(19) United States
(12) Patent Application Publication
(10) Pub. No.: US 2026/0336768 A1
(43) Pub. Date: Oct. 29, 2026

(54) GYROSTABILISER ASSEMBLY

(71) Applicant: VEEM LTD, Canning Vale (AU)

(72) Inventor: Andrey Vladimirovich BEKKER, Canning Vale (AU)

(21) Appl. No.: 19/116,202

(22) PCT Filed: Sep. 27, 2023
(86) PCT No.: PCT/AU2023/050937

§ 371 Date: Mar. 27, 2025

(30) Foreign Application Priority Data
Sep. 27, 2022 (AU) 2022902800
Sep. 27, 2022 (AU) 2022902802

(51) Int. Cl. B63B 39/04; B66C 13/06

(52) U.S. Cl. CPC B63B 39/04; B66C 13/06

(57) ABSTRACT

The disclosure relates to a gyrostabiliser assembly for a marine vessel comprising: a housing defining a chamber for supporting at least a partial vacuum; a flywheel mounted within the chamber; a flywheel shaft on which the flywheel rotates about a spin axis, the flywheel shaft rotatably supported by first and second spin bearings. A first spin bearing chamber accommodates the first spin bearing and is separated from the flywheel chamber by a first shaft seal, and a second spin bearing chamber accommodates the second spin bearing and is separated from the flywheel chamber by a second shaft seal. A lubrication system comprising a lubricant circuit for circulating an oil lubricant to the first and second bearings is located in or adjacent to the second spin bearing chamber. The lubricant circuit outside the housing includes an oil accumulator for storing oil and maintaining pressure of the oil.

### CROSS REFERENCE TO RELATED APPLICATIONS

The present application is a U.S. National Phase of International Application No. PCT/AU2023/050937 entitled “GYROSTABILISER ASSEMBLY,” and filed on Sep. 27, 2023. International Application No. PCT/AU2023/050937 claims priority to Australian Patent Application No. 2022902800 filed on Sep. 27, 2022, and to Australian Patent Application No. 2022902802 filed on Sep. 27, 2022. The entire contents of each of the above-listed applications are hereby incorporated by reference for all purposes.

### TECHNICAL FIELD

The present disclosure relates to a gyrostabiliser assembly, and particularly to a gyrostabiliser assembly having an improved bearing lubrication system.

The gyrostabiliser assembly of the disclosure will typically be designed for use in a marine vessel and it will be convenient to describe it in this exemplary context. It will be appreciated, however, that the gyrostabiliser assembly of the disclosure is not limited to that particular application and may be designed for use in many other applications, such as in other fixed and floating structures, other vehicles, hoisting systems, and/or camera mountings.

### BACKGROUND

The discussion of background art in this specification, including with reference to any documents, should in no way be considered an admission that such background art is well known or forms part of the common general knowledge in the field in Australia or in any other country.

The structure and operation of marine gyrostabiliser assemblies are generally quite well understood and these devices are gaining increasing adoption in commercial and recreational marine vessels. A gyrostabiliser assembly will typically comprise a spinning flywheel mounted in a gimbal frame, and the frame is rigidly mounted within the vessel. The specific way in which the flywheel is constrained in rotational motion allows the angular momentum of the spinning flywheel to combine with the flywheel's precession oscillation to generate large torques that vary with time to directly oppose a dynamic rolling motion of the vessel caused by wind and/or waves. Without any intervention, the vessel rolling motion combines with the flywheel angular momentum to cause oscillating precession motion. This then combines with the angular momentum to create a stabilising torque, which directly opposes undesirable rotational motion (e.g., wave-induced rolling motion) of the vessel. By arranging the gimbals in a specific way, a roll-stabilising device is created using the naturally occurring physics of gyro-dynamics which requires no further intervention to function. An example of a marine gyrostabiliser assembly is described in the present applicant's Australian Patent Application No. AU 2017216483 A1, the contents of which are incorporated herein in their entirety by direct reference.

Due to the high velocity of an outer rim of the flywheel in a gyrostabiliser, the gimbal frame will often comprise a chamber enclosing the flywheel that is evacuated to enable the flywheel to spin within a vacuum. This reduces the aerodynamic drag on the flywheel, reducing power required to maintain the flywheel speed (rpm). It also reduces heat generated by air resistance to the spinning flywheel rim, which in turn improves efficiency. The spin bearings that are used to locate and hold the flywheel about a spin axis are subject to both high loads and high rotational speeds which also generate heat and noise. The spin bearings and spin motor are typically located within the vacuum chamber to avoid issues associated with sealing the vacuum chamber where the spin shaft exits the vacuum chamber. However, having the spin bearings inside the vacuum chamber can make it difficult to lubricate those bearings, as well as to cool the bearings. It can be particularly difficult to cool an inner part of the spin bearings and the flywheel shaft because these are rotating and cannot easily be cooled via contact with a coolant jacket.

The co-pending Australian patent application AU 2017216483 A1 describes an arrangement having an oil lubrication system for lubricating and cooling the bearings, with which an oil flowrate to the bearings can be selected to provide both lubrication and an exchange of heat generated by the bearings into the oil. The oil lubrication system is desirable for reduced noise, extended bearing life, and the ability to remove heat from inner part of the bearings. In this system, the oil is drawn from a sump by one or more scavenge pumps. To allow the scavenge pumps to operate, the arrangement separates an upper bearing chamber and a lower bearing chamber from the vacuum chamber that encloses the flywheel by rotary shaft seals on the flywheel shaft. One seal is below the upper bearing chamber and the other seal is above the lower bearing chamber, with the upper and lower bearing chambers manifolded together by drain lines between them. With this arrangement, the flywheel can spin in a partial- or near-vacuum at sufficiently low pressure that air resistance is substantially reduced or eliminated, while the bearing-housings (which are manifolded so that they operate at the same pressure) are able to operate at a sufficiently high pressure for the scavenge pumps to pump the oil to the spin bearings effectively.

It would be desirable, to provide a new or improved gyrostabiliser arrangement that utilises bearing-housings that are manifolded and isolated from a vacuum chamber and has a lubrication system that can reliably lubricate and cool the spin bearings within their manifolds.

### SUMMARY

According to one broad aspect, the present disclosure provides a gyrostabiliser assembly comprising:
a housing defining a flywheel chamber for supporting an operating pressure;
a flywheel mounted within the flywheel chamber for rotation about a spin axis at the operating pressure;
a flywheel shaft on which the flywheel is mounted in the flywheel chamber, the flywheel shaft being supported by a first spin bearing and second spin bearing located at opposite end regions of the shaft for rotation of the flywheel about the spin axis,
a first spin bearing chamber accommodating the first spin bearing and being separated from the flywheel chamber by a first shaft seal;
a second spin bearing chamber accommodating the second spin bearing and being separated from the flywheel chamber by a second shaft seal; and
a bearing lubrication system comprising a lubricant circuit for circulating a liquid lubricant to the first and second spin bearings from a lubricant reservoir or collection chamber that is located in or adjacent to the second spin bearing chamber and arranged to collect the liquid lubricant from the first and second spin bearings under gravity, wherein the bearing lubrication system includes a pump or “pump means” provided in the reservoir or collection chamber which is coupled to and driven by the flywheel shaft for circulating the lubricant via the lubricant circuit to the first and second spin bearings.

In an embodiment of the disclosure, the pressure in each of the first and second spin bearing chambers is above the operating pressure in the flywheel chamber. In this regard, the pressure in each of the first and second spin bearing chambers is preferably between atmospheric pressure and the operating pressure. Preferably, however, it is not less than about 0.2 bar, and more preferably not less than about 0.4 bar. Accordingly, the first shaft seal and the second shaft seal serve to isolate the first and second spin bearing chambers from the operating pressure in the flywheel chamber.

In an embodiment, the pump means comprises a rotary disc pump, which is a kind of centrifugal pump with an impeller comprising at least one substantially flat or plain disc, and preferably two (or more) substantially flat discs mounted in a spaced, generally parallel arrangement with respect to one another. The impeller is typically without vanes and, when rotated, takes advantage of the principles of boundary layer and viscous drag to impel the liquid lubricant (e.g., oil) from the reservoir or collection chamber along the lubricant circuit. As the impeller of the rotary disc pump is designed without vanes it can be rotated at high speed with substantially laminar flow of the lubricant and without generating significant vibration or cavitation. The rotary disc pump is preferably a closed rotary disc pump. It preferably includes a first solid flat disc mounted in uniform spaced relation to at least one second, axially aligned annular flat disc of substantially the same outer diameter as the first disc. The central opening in the annular disc allows central flow or passage of the oil into the impeller and into the space between the discs. This “pump means” in the reservoir or collection chamber may be called “return pump” for returning lubricant from the reservoir to the lubricant circuit.

In an embodiment of the disclosure, the rotary disc pump includes a plurality of axially aligned annular discs, preferably of substantially the same outer diameter as the first disc. The plurality of annular discs may be mounted in a stacked array above the first disc, preferably substantially uniformly spaced apart in relation to each other and/or in relation to the first disc. The central opening in each of the annular discs is desirably substantially uniform and again allows central flow or passage of the oil into the impeller and into the space between each of the discs. For example, the impeller may include two, three, four, or five annular discs mounted in a stacked array in combination with (at least) one solid disc. With a plurality of annular discs combined with a solid disc, the pressure head generated by the pump and the efficiency of the pump can be substantially improved compared to a single annular disc. The improvements in pressure head and efficiency tend to become smaller once the number of discs exceeds five, however. Desirably, the number of discs provided in the impeller is in the range of two to eight, and preferably five. Each plain or flat annular disc preferably has a radial width in a range of about 20% to about 40% of an outer diameter of the disc. The central aperture of the annular disc thus preferably has a diameter in a range of about 20% to about 60% of the outer diameter of the disc. More preferably, a radial width of each annular disc is in a range of about 25% to about 30% of the outer diameter of the disc. As such, the central aperture of the annular disc will more preferably have a diameter that is in a range of about 40% to about 50% of the outer diameter of the disc. Each disc preferably has a thickness in a range of about 0.5% to about 2% of the outer diameter of the disc.

In an embodiment of the disclosure, a spacing between each of the discs of the impeller is preferably in a range of 0.2 mm to 5.0 mm, more preferably in a range of 0.2 mm to 2.0 mm, and even more preferably in a range of 0.2 mm to 1.5 mm; particularly preferably 0.5 mm. A thickness of each of the discs is preferably in the range of 0.5 mm to 3 mm, with an outer diameter of the discs preferably being in a range of about 100 mm to about 300 mm, and more preferably in a range of about 100 mm to about 200 mm, e.g., a diameter of about 120 mm. The distance between an uppermost (annular) disc of the impeller and a top casing plate of the housing is in a range of 0.05 mm to 0.2 mm. Pins or bolts that interconnect the discs of the impeller preferably have an elliptical cross-sectional profile (e.g., in a ratio of 1:2) thereby presenting a low profile in a direction of rotation of the impeller (i.e., with the shorter elliptical dimension parallel to the radius of the discs).

In an embodiment, the impeller of the rotary disc pump is directly coupled to the flywheel shaft for rotation therewith (i.e., in the absence of gearing). In this way, the impeller of the pump may be rotated with the gyro flywheel shaft at speeds in the range of about 3,000 rpm to about 10,000 rpm. Due to the low hydrodynamic resistance of the impeller, the pump does not require gearing and the high rotational speeds do not lead to excessive wear or any significant cavitation effects in the lubricant.

In an embodiment, the first and second spin bearings have lubricant labyrinths provided around them. The labyrinth of the first (upper) bearing operates to prevent the lubricant (oil) that has been applied to and has flowed through that bearing from flowing onto the flywheel. (This would waste power if the oil were dragged along the chamber wall by the spinning flywheel). The labyrinth of the second (lower) spin bearing acts to keep the lubricant (oil) that has been applied to and has flowed through that bearing off the thrust bearing, which needs its own supply of cooling oil. The lubricant labyrinths redirect the cooling lubricant to the reservoir or collection chamber via channels designed for this purpose. The reservoir or collection chamber is configured and arranged in or on the housing so that the lubricant supplied, circulated, or delivered to the first and second spin bearings drains out of each respective bearing for return to the reservoir under gravity. In this regard, it is understood that the liquid lubricant is typically oil, such as a synthetic oil. In this regard, the lubrication oil will preferably have a vapour pressure less than 40 mbar at 80 °C.

It will be appreciated that the term “spin bearing” used throughout this document is understood as a reference to a bearing designed to mount or support the flywheel shaft for rotation, preferably free rotation, about the spin axis. As such, the term “spin bearing” will be understood as a rotary bearing and will include a range of rotary bearing designs, including a hydrodynamic bearing and a rolling-element bearing.

In an embodiment, the first and second spin bearings are configured as rolling-element bearings; e.g., with an inner race for the rolling elements rigidly attached to the flywheel shaft for rotation with the shaft and an outer race rigidly secured with respect to the housing. In an alternative embodiment, the first and second spin bearings may be configured as plain bearings; e.g., plain hydrodynamic bearings.

In an embodiment, the operating pressure is an at least partial vacuum such that the chamber within which the flywheel is mounted forms a vacuum chamber. This reduces aerodynamic drag on the flywheel, thereby reducing power required to maintain flywheel speed (rpm) while reducing heat generated by air resistance to the spinning flywheel. The operating pressure is preferably less than or equal to about 0.5 bar, more preferably less than 0.2 bar, further preferably in a range of about 1 to 100 mbar (absolute pressure). The pressure values presented herein are values of absolute pressure unless stated otherwise.

In an embodiment, the lubricant circuit, via which the lubricant is circulated from the reservoir or collection chamber to the bearings and then back to the reservoir or collection chamber, preferably includes a further pump external to the housing and flywheel chamber as a start-up, shutdown, and “pressure boost” pump. This external pump may be called a “supply pump” or a “boost pump” and is preferably a vane pump or a positive displacement pump and is preferably magnetically coupled to a brushless electrical motor.

In an embodiment, the bearing lubrication system includes at least one lubricant delivery outlet, especially a lubricant jetting outlet, for targeted delivery or injection of the oil lubricant at each of the first and second bearings. The bearing lubrication system may thus have an ‘oil jet’ system. The oil flowrate is desirably selected to provide or to allow a desired exchange of heat generated at the bearings into the oil. The injection of oil via the jetting outlets ensures that the oil can be targeted at the inner race of each bearing and/or at rolling elements or sliding elements therein to provide effective cooling to these parts. The pump means provided in the reservoir for delivering the lubricant (i.e., oil) from the reservoir to the first and second spin bearings is therefore designed such that it can prime and deliver the necessary pressure to drive the oil with required speed through the oil delivery outlets. In this regard, the “pump means” may comprise a single pump stage or more than one pump stage. By carefully selecting the pump means to deliver the required pressure and flow, the pump means can be arranged and sized to meet the required conditions for circulating the oil through one or more filters and/or one or more heat exchangers in the oil circuit, and then through the oil delivery outlets.

As noted above, the lubrication system may also form a cooling system for the spin bearings. As such, the liquid lubricant (i.e., oil) typically acts as a coolant to carry heat away from the first and second spin bearings. To this end, the lubricant circuit of the bearing lubrication system may include one or more heat exchanger for removing heat from the oil before the oil is delivered to the first and second spin bearings. The channels or conduits for conveying the lubricating oil along the lubrication circuit are preferably at least partially, and optionally fully, integrated or included in the flywheel casing or housing. Further, channels or conduits for conveying a cooling liquid for cooling the lubricating oil are preferably also integrated or included in the flywheel casing or housing to form cooling jacket. In this regard, therefore, walls of the oil labyrinths may form a heat sink or heat exchanger for the oil. Alternatively, or in addition, the walls of the flywheel housing and/or the walls of the reservoir or collection chamber may form a heat sink or heat exchanger for the oil, optionally via a cooling medium provided in those walls (e.g., a water jacket) of the housing or reservoir, and/or optionally via fin elements formed in the walls, as the oil returns to the reservoir under gravity and/or is circulated to the spin bearings from the reservoir. This heat may then be discharged (e.g., overboard) as heated cooling water.

In an embodiment, the lubricant circuit includes an oil accumulator for storing oil and maintaining the oil pressure for cushioning fluctuations in the oil pressure from the pump. The oil accumulator may thus support the jet pressure for oil splashing conditions at the pump and/or for a period of time when oil supply may be absent at the pump inlet to the pump—for example, when the gyrostabiliser may be stuck for an extended period (e.g., 2 minutes) at a high precession angle (e.g., 70°) during a U-turn of the vessel. The oil accumulator is preferably a bladder- or piston-type oil accumulator. The oil pressure maintained by the oil accumulator in the lubricant circuit is preferably in the range of about 1.7 bar to about 3.7 bar (absolute). A non-return valve (check valve) is preferably located upstream of the oil accumulator to prevent back-pressure from the accumulator being exerted on the reservoir.

Both horizontal and vertical orientations of the flywheel shaft are contemplated for the gyroscope assembly of the present disclosure, and each provides challenges for lubrication in terms of getting the lubricant (e.g., oil) to the respective spin bearings and then recovering the lubricant for re-application.

In a preferred embodiment, the flywheel shaft is mounted in a generally vertical orientation within the housing for rotation about a generally vertical spin axis. The first and second bearings therefore form an upper spin bearing and a lower spin bearing, respectively. In such a configuration, the gyroscope assembly of the disclosure typically includes a further lower spin bearing (i.e., a third spin bearing) as a thrust bearing that provides axial support for the flywheel and the flywheel shaft. A vertical flywheel shaft orientation is preferred as this allows the housing to be set up as a pendulum having a natural point of stability near vertical. This means that no extra mechanism is required to ensure that a precession angle of the gyroscope assembly remains ‘centred’ around a mid-stroke. The oil returning from the upper and lower bearings is thus directed to a common reservoir at a lower region or base of the housing below the second (lower) bearing chamber. The oil in the reservoir is then scavenged and (re-)circulated by the rotary disc pump located in the reservoir.

In an embodiment, the pump or “pump means” in the reservoir or collection chamber of the bearing lubrication system includes a two-stage pump arrangement to increase the pump outlet pressure. In such a pump arrangement, the rotary disc pump forms the first stage and the second stage preferably comprises a vaned or bladed centrifugal pump.

In an embodiment, the gyrostabiliser assembly comprises an electric motor for driving rotation of the flywheel about the spin axis. In one embodiment, the spin motor is mounted within the chamber. In an alternative embodiment, the spin motor is mounted outside of the chamber and is coupled to the flywheel shaft via either an isolated magnetic coupling or a sealed shaft connection. The magnetic coupling is preferred to avoid the need for a rotary shaft seal. If a shaft connection is required to a spin motor mounted outside of the chamber, this will again require a rotary shaft seal. An advantage here, however, is that this arrangement is decoupled from the large radial movement (runout) of the flywheel shaft, whereby the runout makes it difficult to seal effectively. Further, the shaft connecting the spin motor to the flywheel shaft only needs to transmit a relatively small spin torque and can therefore be relatively small in diameter. This, in turn, limits the seal contact surface velocities (reduced circumference at a given rpm leads to lower velocities), which substantially extends the possible rpm before the seal capacity become limiting, and reduces the rotational resistance of the seal. By contrast, in the current arrangement the rotary shaft seals are provided on the flywheel shaft that must withstand the full gyro-torque fully reversing at each rpm cycle. The shaft diameter and circumference are thus much greater, leading to higher contact surface velocities, higher wear, and technical challenges with extended seal life.

According to another aspect, the disclosure provides a gyrostabiliser assembly for a marine vessel comprising: a housing defining a flywheel chamber for an operating pressure; a flywheel mounted within the flywheel chamber for rotation about a spin axis at the operating pressure; a flywheel shaft upon which the flywheel is mounted in the flywheel chamber supported by a first spin bearing and a second spin bearing provided at opposite end regions of the flywheel shaft; a first spin bearing chamber that accommodates the first spin bearing and is separated from the flywheel chamber by a first shaft seal; a second spin bearing chamber that accommodates the second spin bearing and is separated from the flywheel chamber by a second shaft seal; and a bearing lubrication system comprising a lubricant circuit for circulating a liquid lubricant to the first and second spin bearings from a lubricant reservoir or collection chamber located in or adjacent to the second spin bearing chamber. The lubricant circuit outside the housing includes an oil accumulator for storing liquid lubricant and maintaining the pressure of the lubricant in the circuit, preferably at a pressure in the range of about 1.7 bar to about 3.7 bar (absolute).

In an embodiment of the gyrostabiliser assembly of the disclosure, the rotary disc pump in the reservoir is coupled to and driven by the flywheel shaft. Alternatively, however, the rotary disc pump may be separate from (i.e., not coupled to) the flywheel shaft and driven by a separate electric motor. As explained above, the rotary disc pump is a kind of centrifugal pump with an impeller comprising at least one substantially flat disc, and desirably two (or more) substantially flat discs mounted in a spaced, generally parallel arrangement with respect to one another. The impeller is typically without vanes and can be rotated at high speed with substantially laminar flow of the lubricant and without generating significant vibration or cavitation. The rotary disc pump is preferably a closed rotary disc pump. It preferably includes a first solid flat disc mounted in uniform spaced relation to a second, axially aligned annular flat disc of substantially the same outer diameter as the first disc.

Because, as noted above, the structure and operation of marine gyrostabilisers are generally quite well-understood, this specification does not aim to provide a detailed description of all of the components of a gyrostabiliser assembly, such as the flywheel, flywheel shaft, gimbal bearings, or the like. Rather, this specification directs the skilled reader to other publications for a description or explanation of those components.

According to another aspect, the present disclosure provides a marine vessel, such as a boat, that includes or incorporates a gyrostabiliser assembly of the disclosure according to any one of the embodiments described above. The gyrostabiliser assembly is typically firmly secured to a hull of the vessel, for example, adjacent a keel.

According to a further aspect, the disclosure provides a hoisting system, e.g., for use with a crane, that includes a gyrostabiliser assembly of the disclosure according to any of the embodiments described above. In this context, the gyrostabiliser assembly is designed or adapted to be suspended with a load from the hoisting system and operates to dampen or suppress undesirable oscillatory rotation, e.g., caused by wind gusts, of the load when suspended during a hoisting operation. At least one gyrostabiliser assembly is desirably provided for, and/or mounted along, each axis of required stabilisation.

It will be appreciated that the term “gyrostabiliser assembly” as used throughout this document is understood as referring to a gyrostabiliser apparatus or gyrostabiliser unit which may be incorporated or installed in a vehicle, such as a marine vessel, or in some other device subject to undesirable rotational motions (like wave-induced rolling motion) in order to counteract and/or reduce such undesirable motions.

### BRIEF DESCRIPTION OF THE DRAWINGS

For a more complete understanding of the invention and advantages thereof, exemplary embodiments of the invention are explained in more detail in the following description with reference to the accompanying drawing figures, in which like reference signs designate like parts and in which:

FIG. 1 is a schematic partially cross-sectional view of a vacuum chamber assembly in a gyrostabiliser assembly according to a preferred embodiment;

FIG. 2 is a schematic diagram of a gyrostabiliser assembly according to a preferred embodiment;

FIG. 3 is a schematic perspective view of the impeller of the rotary disc pump for the sump or reservoir of the gyrostabiliser assembly in the embodiment;

FIG. 4 is a schematic cross-sectional side view of the impeller of the rotary disc pump provided in the sump or reservoir in the gyrostabiliser assembly;

FIG. 5 is a chart illustrating variation in pump efficiency and outlet head or pressure of the rotary disc pump with variation in the number of the discs in the impeller;

FIG. 6 is a schematic cross-sectional view of a hull of a marine vessel that includes a gyrostabiliser assembly according to an embodiment of the disclosure; and

FIG. 7 is a schematic view of a hoisting system that includes a gyrostabiliser assembly according to an embodiment of the disclosure.

The accompanying drawings are included to provide a further understanding of the present invention and are incorporated in and constitute a part of this specification. The drawings illustrate particular embodiments of the invention and, together with the description, serve to explain the principles of the invention. Other embodiments of the invention and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. Furthermore, it will be noted that the elements of the drawings are not necessarily illustrated to scale relative to each other. It will also be understood that certain actions or steps in an embodiment of a method may be described or depicted in a particular order of occurrences while those skilled in the art will understand that such specificity with respect to sequence is not actually required.

### DETAILED DESCRIPTION OF THE EMBODIMENTS

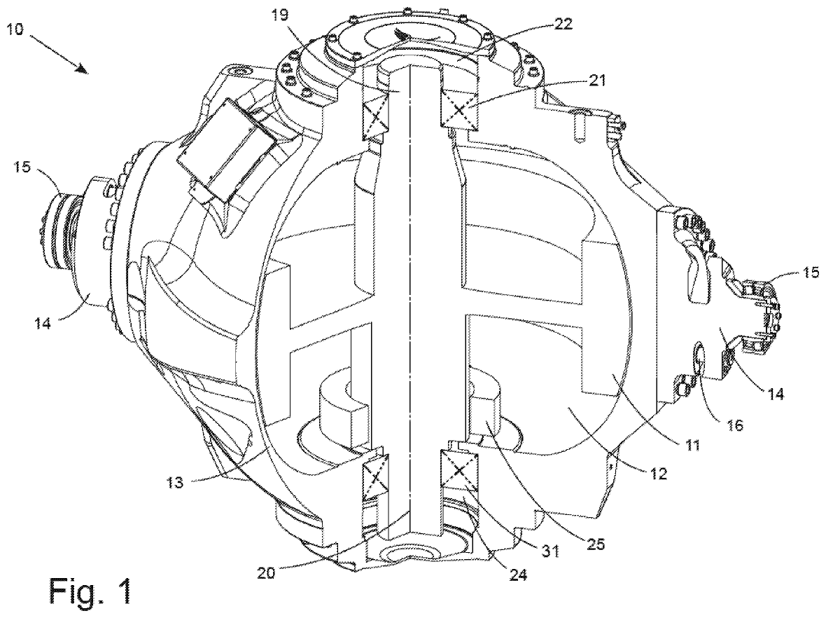

With reference initially to FIG. 1 of the drawings, a gyrostabiliser assembly 1 with a vacuum chamber assembly 10 according to a preferred embodiment of the disclosure is illustrated schematically. The gyrostabiliser assembly 1 includes a housing 13 that encloses a flywheel chamber 12 for supporting a partial vacuum V (e.g., in the range of about 1 to 100 mbar) as an operating pressure, and a flywheel 11 is housed in the flywheel chamber or vacuum chamber 12, formed within the housing 13. The housing is pivotally mounted on precession bearing stubs 14 fixed to the housing 13, with the precession bearings 15 shown fitted to the stub axles 14 defining a precession axis. The rotation of vacuum chamber assembly 10 around the precession axis is controlled by precession control devices, such as dampers or actuators, as is known in the art and the precession bearing stubs 14 also include precession damper or actuator mounts 16. The flywheel 11 is mounted on, fixed to or, as shown, integrally formed with the flywheel shaft 19, which is, in turn, located relative to the housing 13 by upper spin bearing 21 and lower spin bearing 31 such that the flywheel 11 can rotate relative to the housing 13 about the spin axis 20, driven by a spin motor.

In this embodiment, the upper and lower bearings 21, 31 are in the form of rolling-element bearings with rolling elements (e.g., steel balls or steel rollers) that are held and movable between an inner race securely fixed to the shaft 11 and an outer race securely fixed to the housing 13. The generally vertical orientation of flywheel shaft 11 and spin axis 20 allows the housing 13 to be set up or mounted as a pendulum about a generally horizontal axis with a natural point of stability near vertical. As a result, no mechanism is needed to ensure that a precession angle of the gyroscope assembly 1 remains centred around a mid-stroke. The upper spin bearing 21 is positioned within an upper spin bearing chamber 22 and similarly the lower spin bearing 31 is positioned within a lower spin bearing chamber 24. Recirculating oil lubrication systems were not typically provided in gyrostabilisers in which the flywheel shaft 34 is nominally vertical (i.e., in use oscillating up to +/−70 degrees for example either side of vertical) as shaft seals provided between the vacuum chamber 12 and the spin bearing chambers 22, 24 had leakage issues due to the high surface speed and large runout, as discussed above; hence, the typical use of viscous grease in such applications, as it holds in place. The present arrangement of an oil circuit in the gyrostabiliser assembly 1 described in detail below is leakage tolerant, however, enabling oil that may leak from the bearing chambers 22, 24 into the flywheel chamber 12 to be purged back into the oil circuit.

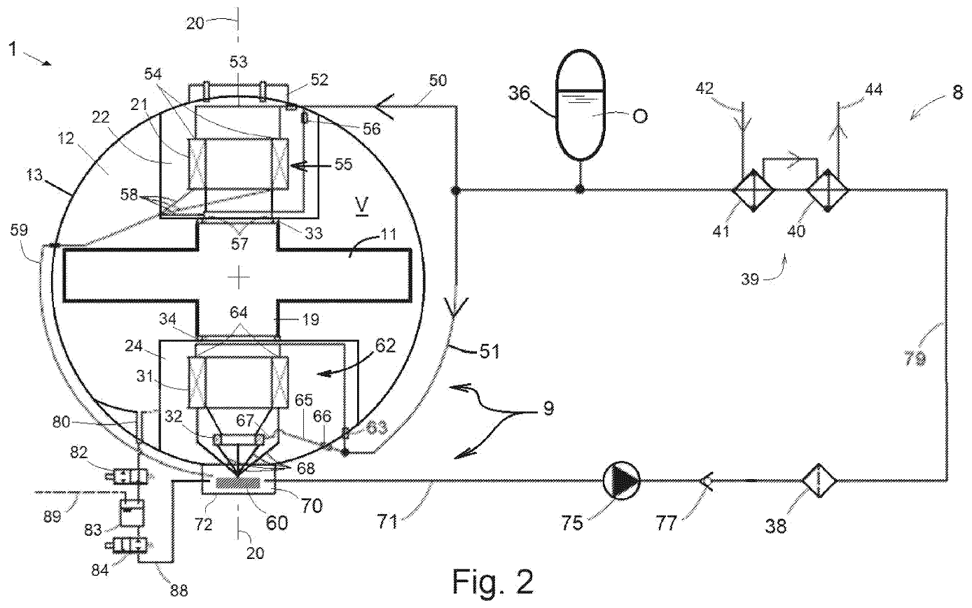

With reference to FIG. 2 of the drawings, the gyrostabiliser assembly 1 includes a lubrication system (oil-based) for the upper and lower spin bearings 21, 31 configured to circulate oil O to each of the spin bearings 21, 31 from an oil reservoir or collection chamber 70. FIG. 2 shows the lubrication system 8 or oil circuit 9 providing lubrication and cooling of the upper spin bearing 21, first lower spin bearing 31 and second lower spin bearing 32. The second lower spin bearing 32 can be a bearing type suited to large thrust loads to support the flywheel (omitted from FIG. 1 for clarity). FIG. 2 also shows seals 33, 34 between the bearing chambers 22, 24 and the flywheel chamber 12 to allow the bearing chambers to be at a different pressure to the vacuum chamber and to prevent free flow of the lubrication oil into the vacuum chamber 12. In this regard, the first and second bearing chambers 22, 24 are preferably at a pressure in the range of about 0.3 bar to 1 bar, and more preferably 0.4 bar to 0.6 bar (absolute). There are two primary benefits of the bearing chambers 22, 24 being at a different pressure to the vacuum chamber: firstly, pumping oil out of the vacuum chamber is not straightforward due, for example, to cavitation; and secondly, the pressure differential between the vacuum chamber 12 and each of the spin bearing chambers 22, 24 can assist with energising of the seals 33, 34. The seals 33, 34 are located around the flywheel shaft 19 and can be any suitable rotary shaft seal. The electric drive motor or spin motor 52 for driving rotation of the flywheel 11 and shaft 19 about the spin axis 20 is mounted on the housing 13 and is operatively coupled to the flywheel shaft 19 via a magnetic coupling 53.

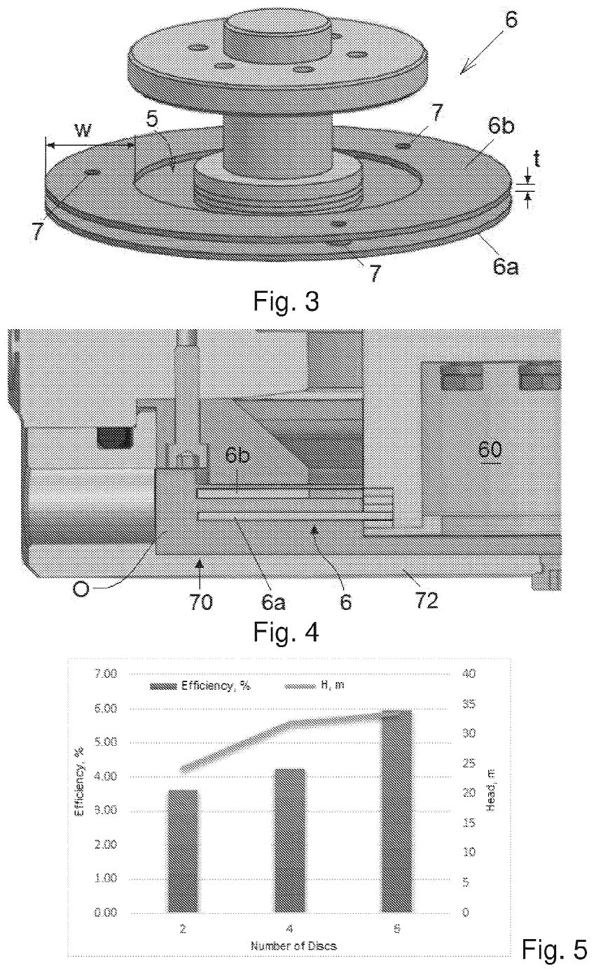

The lubrication system 8 thus includes an oil circuit 9 comprising a series of interconnected lines or conduits 71, 79, 50, 51, 58, 59, 65 via which the oil O is pumped or circulated from the reservoir or collection chamber 70 to the respective spin bearings 21, 31, 32 and then back to the reservoir 70. To this end, the lines or conduits 71, 79, 50, 51, 65 of the oil circuit 9 may be both (i.e., partially) external to and (partially) within the housing 13 through which the oil O is delivered or supplied to each of the spin bearings 21, 31, 32 from the oil reservoir 70. The upper and lower spin bearings 21, 31 are configured and arranged in the housing 13 such that the oil O circulated or delivered to the spin bearings 21, 31 drains out of each respective bearing 21, 31 for return to the reservoir 70 under gravity. In this connection, the lubrication system 8 includes at least one pump 60 in the reservoir or collection chamber 70 that is coupled to and driven by the flywheel shaft 34 for circulating the lubricant oil O via the oil circuit 9 to the first and second spin bearings 21, 31. The pump 60 comprises a rotary disc pump, which is a kind of centrifugal pump with an impeller 6 as shown in FIGS. 3 and 4. The impeller 6 comprises two substantially flat discs 6a, 6b, one disc 6a being of a generally solid circular shape and the other disc 6b generally annular or ring shaped, mounted coaxially in spaced apart, generally parallel arrangement with respect to one another by threaded stems, bolts, or other fasteners 7, with a spacing between the discs of about 0.5 mm. These stems or bolts 7 interconnecting the discs 6a, 6b of the impeller 6 have an elliptical cross-sectional profile (e.g., in a ratio of 1:2) for a low profile in a direction of rotation of the impeller 6 (i.e., with the shorter elliptical dimension parallel to the disc radius).

The annular disc 6b has a central aperture 5 for passage of oil into the space between the discs 6a, 6b and substantially the same outer diameter as the solid circular disc 6a. The radial width w of the annular disc 6b is about 25% of the outer diameter (120 mm) of the disc. Thus, the central aperture 5 of the annular disc has a diameter that is about 50% of the outer diameter of the disc 6b. The thickness t of each disc 6a, 6b is preferably in a range of about 0.5 mm to 2.0 mm. The impeller 6 is without vanes and, when rotated, utilises the principles of boundary layer and viscous drag to impel the oil O from the sump or reservoir 70 along the lubricant circuit 9. As the impeller 6 of the rotary disc pump 60 is designed without vanes it can be rotated at high speed with substantially laminar flow of the lubricant and without generating significant vibration or cavitation. In this way, the impeller 6 of the rotary disc pump 60 may be rotated with the gyro flywheel shaft 34 at speeds in the range of about 3,000 rpm to about 10,000 rpm. Due to the low hydro-dynamic resistance of the impeller 6, the pump 60 does not require gearing and the high rotational speeds do not create any significant cavitation effects in the oil. The rotary disc pump 60 thus operates for circulating or delivering the oil from the reservoir 70 to the upper and lower bearings 21, 31. The vertical orientation of the spin axis 20 means that oil O supplied to upper and lower bearings 21, 31 is directed to the reservoir or collection chamber 70 via gravity. That is, the reservoir or collection chamber 70 is located at a base of the housing 13 below the lower bearing chamber 24 to collect the oil via return lines or channels 58, 59, 68 from the upper and lower spin bearings 21, 31 and thrust bearing 32 under gravity.

With reference to FIG. 5 of the drawings, it will be noted that the pump 60 may have an impeller 6 with a plurality of axially aligned annular discs 6b in a stacked array above the solid disc 6a, and uniformly spaced apart in relation to each other and in relation to the solid disc 6a. The central opening 5 in each of the annular discs 6b is substantially uniform and again allows central passage of the oil O into the impeller 6 and into the space between each of the discs 6a, 6b. For example, the impeller may include two, three, four or five annular discs 6b mounted in a stacked array in combination with a solid disc 6a. As seen in FIG. 4, the pressure head generated by the pump 60 as well as its efficiency can be significantly improved by increasing the number of rotary discs 6a, 6b, although the improvements tend to become smaller once the number of discs exceeds five. FIG. 4 illustrates the disc pump efficiency and pressure head for synthetic (polyalphaolefin) oil O at 80 °C at 7 l/min flow rate, disc diameter of 120 mm, and a shaft speed 4800 rpm.

Referring back to FIG. 2, the lubricant circuit 9 includes a further pump 75 external to the housing 13 and vacuum chamber 12 which is provided as a start-up, shutdown, and pressure boost pump. In this way, this further pump 75 may be employed to generate oil pressure in the lubricant circuit 9 before the flywheel 33 and flywheel shaft 34 have commenced operation (i.e., before the rotary disc pump 60 is operational). This pump 75 may also operate to boost the oil pressure in the lines or conduits 71, 79, 50, 51 for improved oil delivery to the bearings 21, 31 when the rotary disc pump 60 is operating. This external pump 75 may, for example, be a vaned centrifugal pump and it may be magnetically coupled to a brushless electrical motor. From the pump 75, the oil flows in the oil circuit 9 through a check valve 77 and through a filter 38, with the oil O passing via conduit 79 to an oil cooler 39. The oil cooler 39 is shown as two heat exchanger units 40, 41 in series with coolant supplied or flowing in through a line or conduit 42 and out through a line or conduit 44. Oil exits the cooler 39 and flows to an oil accumulator 36, which stores the oil O and maintains the oil pressure in order to cushion fluctuations in the oil pressure from the pumps 60, 75. The oil pressure maintained by the oil accumulator in the oil circuit 9 is preferably in the range of about 1.7 bar to about 3.7 bar (absolute). The check valve (i.e., non-return valve) 77 located upstream of the oil accumulator 36 avoids back-pressure from the accumulator 36 being exertion on the sump or reservoir 70. The oil accumulator 36 can thus support the oil jetting pressure at the bearing 21, 31 for oil splashing conditions at the pump 60 and/or when oil supply may be absent at the inlet to the pump 60 for a period of time—e.g., when the gyrostabiliser 1 experiences an extended period at a high precession angle (e.g., 70°) during a U-turn of the vessel. The oil accumulator 36 is preferably a bladder- or piston-type oil accumulator. Downstream of the accumulator 36, the oil flow is then split between a conduit 50 towards the upper spin bearing 21 and a conduit 51 towards the lower spin bearing 31, as well as to the thrust bearing 32. It will be noted that the oil accumulator 36 can be located anywhere along the oil circuit 9 between the pump 75 and the split in the oil line to the two conduits 50, 51.

The oil lubrication system 8 includes an oil-jetting outlets 54, 64, 67 at each of the upper and lower spin bearings 21, 31 and thrust bearing 32 for targeted delivery or injection of the oil O via the oil circuit 9. The oil flowrate is selected to provide a desired exchange of heat generated at the bearings 21, 31, 32 into the oil. The oil lubrication system 8 therefore also forms a cooling system for the bearings 21, 31, 32 in which the oil acts as a coolant to carry heat away from the bearings. In particular, the oil injection via jetting outlets 54, 64 ensures that the oil O is targeted at an inner race of each of the rotary bearings 21, 31 and/or at the rolling elements or sliding elements therein with sufficient velocity and pressure so that it mixes with the boundary layer oil for effective lubrication as well as cooling. To this end, the oil circuit 9 includes the heat exchangers 40, 41 for removing heat from the oil before the oil O is delivered to the upper and lower bearings 21, 31. In this regard, walls 72 of the reservoir or collection chamber 70 may form or act as a heat exchanger for the oil O, optionally via a cooling medium provided in the walls 72 (e.g. in the manner of a water jacket) and/or via fin elements (not shown) formed in the walls, as the oil returns to the reservoir 70 under gravity. The oil circuit 9 also includes at least one filter 38 for filtering the oil O prior to its re-injection at the jetting outlets 54, 64, 67.

With further reference to FIG. 2 of the drawings, it will be seen that the upper and lower bearings 21, 31 have oil labyrinths 55, 62 provided around them to prevent the oil O applied to the bearings 21, 31 from flowing where it should not, such as onto the flywheel 33 or onto the thrust bearing 32, which is separately cooled via the line 65 and jetting nozzle 67. These oil labyrinths 55, 62 direct the flow of the oil to the reservoir or collection chamber 70 via the return lines or channels 58, 59, 68. As noted above, the reservoir or collection chamber 70 is arranged in or on the housing so that the oil supplied, circulated, or delivered to the first and second spin bearings 21, 31 and thrust bearing 32 drains out of each respective bearing 21, 31, 32 via the respective oil labyrinth 55, 62 for return to the reservoir 70 under gravity. The oil is desirably a synthetic oil with a vapour pressure less than 40 mbar at 80 °C.

The oil reservoir or collection chamber 70 also functions as an oil de-aerator, but may also provide other functions, such as allowing contaminants to settle out and/or to provide passive cooling of the oil O. Any oil drawn past the upper or lower shaft seals 33, 34 into the vacuum chamber 12 accumulates in the bottom of the vacuum chamber and collects in the oil scavenge cavity 80. However, pumping the oil out of the vacuum chamber oil scavenge cavity 80 can again be difficult due to cavitation. The pumping arrangement 81 uses the pressure differences between the vacuum chamber 12, the oil collection chamber 60 (and spin bearing chambers 22, 24) and atmosphere to pump oil from the vacuum chamber oil scavenge cavity 80 to the oil collection chamber 70. An upper valve 82, which can be a switchable one-direction valve or lockout valve, allows the vacuum chamber oil scavenge cavity 80 to be connected selectively to a lubrication oil recovery (LOR) tank 83. The lower valve 84 selectively allows the LOR tank 83 to be connected to the oil collection chamber 60 via oil return conduit 88. The LOR tank 83 is thus normally switched to a state in which it is open to the vacuum chamber 12 (i.e., at the operating pressure) for the better oil collection.

The advantages of the rotary disc pump 60 include that: it can run dry without damage, it is operable at higher temperatures, it benefits from a higher viscosity fluid; it generates substantially laminar flow with virtually no cavitation; it requires very little maintenance; it is inexpensive to produce; it has a low height profile; it requires no running-in period; it can pump a gas-liquid mixture; it is suitable to run at high rpm; and it does not impede start-up pump operation.

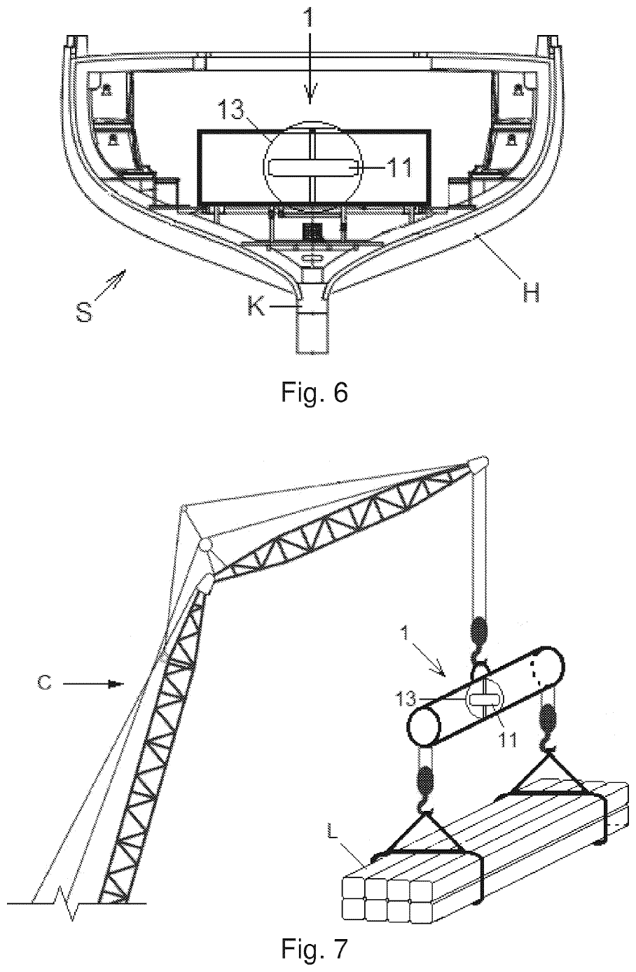

Referring to FIG. 6 of the drawings, a marine vessel S, such as a ship, yacht, or boat, is shown including a gyrostabiliser assembly 1 according to an embodiment of the disclosure described above. The gyrostabiliser assembly 1 is securely fixed to a hull H of the vessel S adjacent a keel K.

With reference to FIG. 7 of the drawings, a hoisting system, such as a crane C, is shown, having a gyrostabiliser assembly 1 according to an embodiment of the disclosure as described above. In this context, the gyrostabiliser assembly 1 is designed to be suspended from the hoisting system and operates to dampen or suppress undesirable oscillatory rotation, e.g., caused by wind gusts, of a suspended load L during a hoisting operation. A gyrostabiliser assembly 1 is provided for, and/or mounted along, each axis of required stabilisation.

Although specific embodiments of the invention are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

Generally, the present disclosure is intended to cover any and all adaptations or variations of the specific embodiments discussed herein. By way of example, a skilled person will readily appreciate that the gyrostabiliser assembly 1 and the systems of this disclosure are not limited to being made from any particular material described in the specific embodiments. Rather, the skilled person will appreciate that a range of suitable materials exist, and the skilled person can readily select a suitable material based upon the known mechanical properties of that material which make it suitable for use in this disclosure. As the present disclosure involves engineering technology from a number of disciplines, it is expected that the notional ‘skilled person’ may comprise a group or a team of individuals having technical expertise and/or qualifications in one or more of the fields or disciplines including mechanical engineering, marine engineering and hydraulic engineering.

It will also be appreciated that the terms “comprise”, “comprising”, “include”, “including”, “contain”, “containing”, “have”, “having”, and variations thereof used in this document are, unless the context indicates otherwise, intended to be understood in an inclusive (i.e. non-exclusive) sense, such that the process, method, device, apparatus, or system described herein is not limited to those features, integers, parts, elements, or steps recited but may include other features, integers, parts, elements, or steps not expressly listed and/or inherent to such process, method, device, apparatus, or system. Further, the terms “a” and “an” used herein are intended to be understood as meaning one or more unless explicitly stated otherwise. Moreover, the terms “first”, “second”, “third” etc. are used merely as labels and are not intended to impose any numerical requirements on or to establish any ranking of importance of their objects. In addition, reference to positional terms, such as “lower” and “upper”, used in the above description are to be taken in context of the embodiments depicted in the figures, and are not to be taken as limiting the invention to the literal interpretation of the term but rather as would be understood by the skilled addressee in the appropriate context.

Reference signs

| | |
|---|---|
| 1 | gyrostabiliser assembly |
| 5 | central aperture |
| 6 | impeller |
| 6a | solid flat disc |
| 6b | annular or ring shaped disc |
| 7 | stem, bolt, or fastener |
| 8 | lubrication system |
| 9 | oil circuit |
| 11 | flywheel |
| 12 | vacuum chamber |
| 13 | housing |
| 14 | stub/stub axle |
| 15 | precession bearing |
| 19 | flywheel shaft |
| 20 | spin axis |
| 21 | upper bearing |
| 31 | lower bearing |
| 32 | thrust bearing |
| 33 | upper shaft seal |
| 34 | lower shaft seal |
| 36 | oil accumulator |
| 38 | filter |
| 39 | oil cooler |
| 40 | heat exchanger |
| 41 | heat exchanger |
| 42 | coolant supply line |
| 44 | coolant supply line |
| 50 | oil supply line |
| 51 | oil supply line |
| 52 | electric motor |
| 53 | magnetic coupling |
| 54 | oil jetting outlet |
| 55 | oil labyrinth |
| 58 | lubricant return channel/drain line |
| 59 | lubricant return channel/drain line |
| 60 | pump means |
| 62 | oil labyrinth |
| 64 | oil jetting outlet |
| 65 | oil supply line |
| 67 | oil jetting outlet |
| 68 | lubricant return line or channel |
| 70 | reservoir or collection chamber |
| 71 | oil supply line |
| 72 | wall of reservoir/collection chamber |
| 75 | positive displacement pump |
| 77 | check valve |
| 79 | oil supply line |
| V | partial vacuum |
| O | lubricant/oil |
| w | radial width of annular disc |
| t | thickness of annular disc |
| S | marine vessel or ship |
| H | hull |
| K | keel |
| C | hoisting system or crane |
| L | load |

1. A gyrostabiliser assembly comprising:
a housing defining a flywheel chamber for an operating pressure;
a flywheel mounted within the flywheel chamber for rotation about a spin axis at the operating pressure;
a flywheel shaft upon which the flywheel is mounted in the flywheel chamber supported by a first spin bearing and a second spin bearing provided at opposite end regions of the flywheel shaft;
a first spin bearing chamber accommodating the first spin bearing and being separated from the flywheel chamber by a first shaft seal;
a second spin bearing chamber accommodating the second spin bearing and being separated from the flywheel chamber by a second shaft seal; and
a bearing lubrication system comprising a lubricant circuit for circulating a liquid lubricant to the first and second spin bearings from a lubricant reservoir or collection chamber located in or adjacent to the second spin bearing chamber for collecting the liquid lubricant from the first and second spin bearings under gravity, wherein a pump is provided in the reservoir or collection chamber that is coupled to and driven by the flywheel shaft for circulating the lubricant in the lubricant circuit to the first and second bearings.

2. The gyrostabiliser assembly according to claim 1, wherein the pump provided in the reservoir comprises a rotary disc pump, wherein an impeller of the rotary disc pump is rotated by the flywheel shaft at speeds in the range of about 3,000 rpm to about 10,000 rpm.

3. The gyrostabiliser assembly according to claim 2, wherein the rotary disc pump is arranged within the reservoir or collection chamber submerged in the lubricant.

4. The gyrostabiliser assembly according to claim 1, wherein an impeller of the pump includes at least two substantially plain or flat discs mounted in an axially aligned and generally parallel arrangement with respect to one another, wherein the at least two substantially plain or flat discs include a first solid disc and a second annular disc of substantially same outer diameter as the first disc.

5. The gyrostabiliser assembly according to claim 1, wherein the pump means provided in the reservoir or collection chamber is selected from the group of: a gerotor pump (i.e., “generated rotor” pump), a bladed centrifugal pump, a vaned pump, or a positive displacement pump; or wherein the pump means comprises a two-stage pump arrangement, wherein a rotary disc pump coupled to and driven by the flywheel shaft forms a first stage, and wherein a centrifugal pump with a vaned impeller forms a second stage.

6. The gyrostabiliser assembly according to claim 1, wherein the liquid lubricant is oil, such as a synthetic oil, and wherein the oil preferably has a vapour pressure less than 40 mbar at 80 °C.

7. The gyrostabiliser assembly according to claim 1, wherein the lubricant circuit outside the housing includes an oil accumulator for storing liquid lubricant and maintaining pressure of the lubricant, preferably at a pressure in the range of about 1.2 bar to about 3.2 bar (absolute).

8. The gyrostabiliser assembly according to claim 1, wherein the lubricant circuit, via which the lubricant is circulated from the reservoir or collection chamber to the bearings and back, includes a positive displacement pump external to the housing chamber as a start-up, shutdown, and pressure boost pump, wherein this external pump is preferably a vane pump and is preferably magnetically coupled to a brushless electrical motor.

9. The gyrostabiliser assembly according to claim 1, wherein the first and second spin bearings have lubricant labyrinths around them to prevent the lubricant applied to the first and second spin bearings from flowing onto the flywheel; wherein the lubricant labyrinths are adapted to redirect the lubricant to the reservoir or collection chamber via channels.

10. The gyrostabiliser assembly according to claim 1, wherein the lubrication system includes a lubricant delivery outlet, especially a jetting outlet, for targeted delivery or injection of the lubricant at each of the first and second spin bearings.

11. The gyrostabiliser assembly according to claim 1, wherein the first and second spin bearings are configured and arranged within the housing such that lubricant circulated to the first and second spin bearings drains out of each respective spin bearing for return to the reservoir or collection chamber under gravity.

12. The gyrostabiliser assembly according to claim 1, wherein the flywheel shaft is mounted in an essentially vertical orientation within the housing for rotation about an essentially vertical spin axis, wherein the first and second spin bearings comprise an upper spin bearing and a lower spin bearing, respectively.

13. The gyrostabiliser assembly according to claim 1, comprising an electric motor for driving rotation of the flywheel about the spin axis, wherein the electric motor is mounted outside of the housing chamber and is coupled to the flywheel shaft via a magnetic coupling.

14. The gyrostabiliser assembly according to claim 1, wherein the operating pressure is a partial vacuum or rough vacuum in a range of about 1 mbar to 100 mbar absolute pressure such that the chamber in which the flywheel is mounted forms a vacuum chamber.

15. A gyrostabiliser assembly comprising:
a housing defining a flywheel chamber for an operating pressure;
a flywheel mounted within the flywheel chamber for rotation about a spin axis at the operating pressure;
a flywheel shaft upon which the flywheel is mounted in the flywheel chamber supported by a first spin bearing and a second spin bearing provided at opposite end regions of the flywheel shaft;
a first spin bearing chamber accommodating the first spin bearing and being separated from the flywheel chamber by a first shaft seal;
a second spin bearing chamber accommodating the second spin bearing and being separated from the flywheel chamber by a second shaft seal; and
a bearing lubrication system comprising a lubricant circuit for circulating a liquid lubricant to the first and second spin bearings from a lubricant reservoir or collection chamber located in or adjacent to the second spin bearing chamber, wherein the lubricant circuit outside the housing includes an oil accumulator for storing liquid lubricant and maintaining pressure of the lubricant, at a pressure in the range of about 1.7 bar to about 3.7 bar (absolute).

16. The gyrostabiliser assembly according to claim 15, wherein a rotary disc pump is provided in the reservoir or collection chamber for circulating the lubricant in the lubricant circuit to the first and second bearings, wherein the rotary disc pump in the reservoir or collection chamber is coupled to and driven by the flywheel shaft.

17. The gyrostabiliser assembly according to claim 15, wherein a pump is provided in the reservoir or collection chamber that is coupled to and driven by the flywheel shaft for circulating the lubricant in the lubricant circuit to the first and second bearings; or alternatively,
wherein a pump is provided in the reservoir or collection chamber separate from the flywheel shaft and driven by an electric motor for circulating the lubricant in the lubricant circuit to the first and second bearings.

18. The gyrostabiliser assembly according to claim 17, wherein the pump has an impeller comprising two substantially flat discs mounted in a spaced, generally parallel arrangement with respect to one another, and including a first solid flat disc and a second, axially aligned annular flat disc.

19. The gyrostabiliser assembly according to claim 18, wherein the impeller includes a plurality of flat annular discs mounted in an axially aligned and generally parallel arrangement with respect to one another.

20. The gyrostabiliser assembly according to claim 18, wherein an outer diameter of each disc of the impeller is in a range of about 100 mm to 200 mm.

21. The gyrostabiliser assembly according to claim 18, wherein a radial width of each annular disc is in a range of about 20% to about 40% of an outer diameter of the annular disc.

22. A marine vessel, comprising the gyrostabiliser assembly according to claim 1.

23. A hoisting system comprising the gyrostabiliser assembly according to claim 1, wherein the gyrostabiliser assembly is adapted to be suspended with a load from the hoisting system.
